(19) United States
(12) Patent Application Publication
(10) Pub. No.: US 2008/0237209 A1
(43) Pub. Date: Oct. 2, 2008

(54) Electric vest for treatment of anatomically-interrelated regions of the upper torso

(76) Inventor: Robert E. Gibbons, Calabasas, CA (US)

Correspondence Address: Elliott N. Kramsky, Esq., Suite 400, 5850 Canoga Avenue, Woodland Hills, CA, 91367, US

(21) Appl. No.: 11/728,527

(22) Filed: Mar. 26, 2007

(51) Int. Cl. H05B 3/34

(52) U.S. Cl. 219/211

(57) ABSTRACT

An electric vest for therapeutic heating of the upper torso. An insulated electrical conductor is fixed to a canvas matrix by means of metal clips. The canvas matrix in layout resembles a face shaped region with radially-directed ears shaped regions so that, when worn over the shoulders of user, the pectoralis muscles of the upper chest, the trapezius muscles of the upper back and the posterior cervical muscles are covered. The electrical conductor is fixed to a path traversing the canvas matrix whereby heating is simultaneously provided to the neck, upper back and upper chest regions of the wearer.

### BACKGROUND

1. Field of the Invention

The present invention relates to apparatus for delivering therapeutic heat. More particularly, this invention pertains to a vest for the targeted delivery of therapeutic heat to anatomically-interactive regions of the upper torso (i.e. neck, upper thoracic, mid-thoracic and upper chest regions).

2. Description of the Prior Art

The benefits that result from the application of heat to muscle are well known. Such heat serves to relax muscle fibers and increase circulation to promote healing. For this reason, the application of heat is indicated for the treatment of numerous conditions including, but not limited to, pain due to arthritis and minor disk problems, tension and migraine headaches, neuropathy and the like.

Heating pads have long been recognized as a means for application of such therapies. The pad typically includes a heating element housed within a cover of rectangular shape. A strap or other closure means may be provided to permit the user to fixedly attach the pad to the portion of the body in the region of desired application of the heat. The heating element often comprises an insulated wire, or other heating element(s), that is electrically connected to a source of house current through a controller that the user operates, setting the temperature and duration of treatment. Examples of such heating pads are those described in the following U.S. Pat. No. 2,032,294 of McDonald covering “Electric Heating Pad”; U.S. Pat. No. 4,937,435 of Goss et al. covering “Flexible Electric Heating Pad uning PTC Ceramic Thermistor Chip Heating Elements”; U.S. Pat. No. 5,151,578 of Phillips covering “Anisotropically Bendable Heating Pad”; U.S. Pat. No. 5,432,322 of Ingram covering “Electric Heating Pad”; and U.S. Pat. No. 6,300,597 of Lee covering “Electromagnetic Field Shielding Electric Heating Pad”.

Other heating pads operate substantially as above, but are configured to address specific anatomical regions. Often such specific targeting of the pad will result in a dedicated pad geometry. Examples of such types of heating pads are disclosed in the following U.S. Pat. No. 2,497,433 of Eatman covering “Form Fitting Heating Pad”; U.S. Pat. No. 3,103,219 of Chadner covering “Sleep Inducing Heating Pad”; U.S. Pat. No. 4,628,188 of Andreasson covering “Electric Heating Pad For Seats and Back-Rests”; and U.S. Pat. No. 5,436,429 of Cline covering “Flexible Electric Heating Pad For Wrapping Around a Baby Bottle Powered by Vehicle Cigarette Lighter Plug”. A vest for application of heat to portions of the back and shoulders of a user is marketed as “Moist Heating Pad/Shoulder Model” by Mill Products BV of Nunspeet, The Netherlands.

While electric heating pads have been developed and are available in a variety of configurations, none of the above-described prior art offers an anatomically correct and complete solution to the problems that are related to muscle stress throughout the muscle groups in the shoulder, neck and upper back and upper chest regions. Tension within such muscle groups, which are either directly coupled or indirectly related to one another through the skeletal structure, are not comprehensively addressed by the heating patterns provided by the above-described art.

### SUMMARY OF THE INVENTION

The present invention addresses the preceding and other shortcomings of the prior art by providing an electric heating vest for applying heat to predetermined areas of the body of a wearer. Such vest includes an electrical cord that is fixed in a pattern on a flexible matrix having a boundary.

The flexible matrix is shaped to include regions for overlying predetermined muscle groups of the upper torso of the wearer. The pattern of the electrical cord traverses the regions of the flexible matrix shaped to overlie the pectoral, trapezius and cervical muscle groups of the wearer.

The preceding and other features of the invention are described in a detailed description that follows. Such description is accompanied by a set of drawing figures. Numerals of the drawing figures, corresponding to those of the written description, point to the features of the invention. Like numerals refer to like features throughout both the written description and the drawings.

### BRIEF DESCRIPTION OF THE DRAWINGS

FIG. 1 is an electrical schematic view of an upper torso treatment system 10 including an electric heating vest 12 in accordance with an embodiment of the invention;

FIGS. 2A and 2B are perspective and rear views respectively of an electric heating vest in accordance with the invention in use;

FIGS. 3A and 3B are front and rear views respectively for illustrating the locations and general shapes of the major muscles of the upper torso of a human being;

FIG. 4 is an exploded view illustrating the interior of an electric heating vest in planar layout in accordance with an embodiment of the invention; and

FIG. 5 is a cross-sectional view of the electric vest taken at line 5-5 of FIG. 2B.

### DETAILED DESCRIPTION OF THE PREFERRED EMBODIMENT

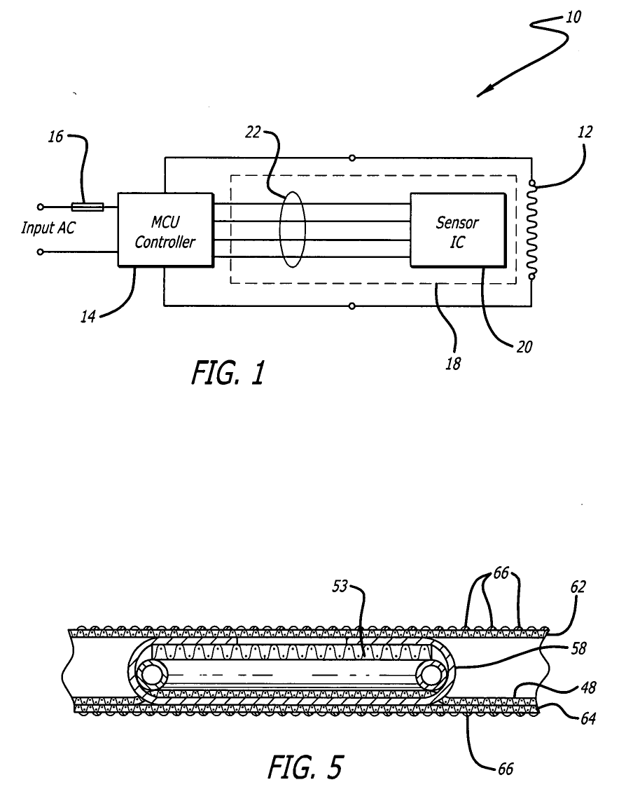

Turning now to the drawings, FIG. 1 is an electrical schematic view of an electric heating vest 10 in accordance with an embodiment of the invention. The vest comprises an electrical cord 12 that provides resistive heating in a patterned manner throughout the vest. It will be seen below that the arrangement of the cord 12 with respect to a flexible matrix effectively positions the heat output to target the muscle groups of the upper torso in a comprehensive manner so that ailments associated with muscular strain are effectively treated.

The vest 10 utilizes standard a.c. home current. Such current is selectively transformed into an output for energizing the electrical cord 12 to produce a desired degree of heating by means of a controller 14 which is protected from surges in home current by means of a fuse 16. A temperature sensor 18 includes an integrated sensor chip 20. A plurality of conductors 22 provides electrical communication between the controller 14 and the integrated sensor chip 20, forming a control system for assuring that the temperature selected at the controller 14 is maintained throughout operation of the vest 10. Conductors 24, 26 provide electrical communication between the controller 14 and the electrical cord 12 which acts as the heating element of the vest 10.

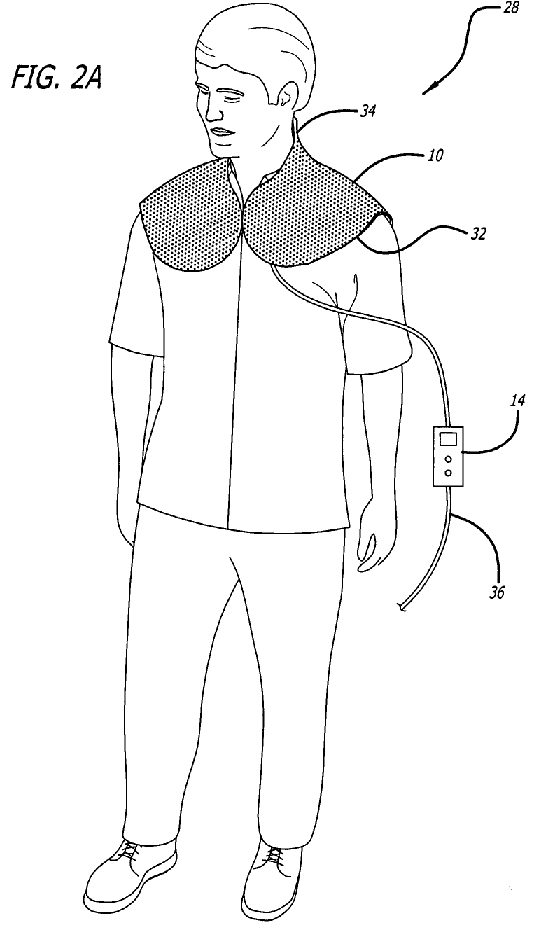

FIGS. 2A and 2B are perspective and rear views respectively of the electric heating vest 10 (enclosed within an outer cover of cotton of conforming shape to a canvas matrix and inner cover discussed below) in accordance with the invention in use. As shown, the vest 10 includes portions that overlie areas of the upper torso of a wearer 28. In particular portions of the vest 10 cover the upper back 30, chest 32, and neck (rear and lateral portions) 34 of the wearer 28. An electrical conductor 36 with a plug end (not shown) provides electrical communication between the vest 10 and a conventional a.c. electrical outlet. The controller 14 permits the wearer 28 adjust the intensity and character of the heat provided by the vest 10.

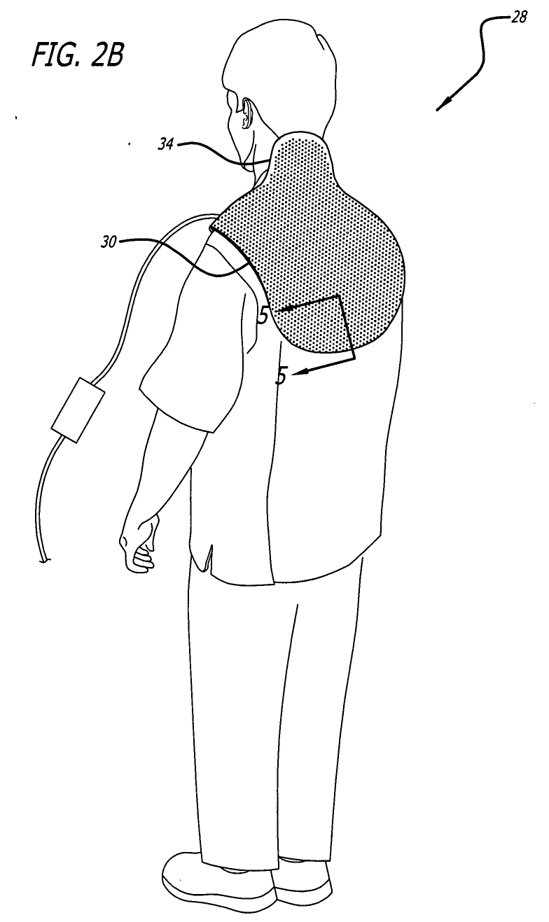

FIGS. 3A and 3B are front and rear views respectively for illustrating the locations and general shapes of the major muscles of the upper torso of a human being 38. The vest 10 is designed to address “complementary” muscle groups of the upper torso. Complementary refers to the fact that numerous conditions that may be advantageously treated by the application of heat involve interrelationships between muscle groups of the upper back, chest and neck. In some cases, the relationships are direct in the sense that muscle groups are connected or abut while other relationships re indirect in the sense that the condition of one muscle group is transferred to another muscle group through the mutual relationships of the two groups of muscles to the human skeleton.

Referring to FIGS. 3A and 3B in combination, the trapezius muscles 40, generally diamond shaped, cover the middle of the back between the shoulder blades. Such muscles are the largest group in the area of the upper torso. Many other muscle groups, also beneficially affected by the application of heat, form a diamond shape that underlies the trapezius muscles 40. Such muscles include the rhomboids, infraspiritus and supraspiritus muscle groups. Muscle groups of the neck include the posterior cervical muscle group 44. Finally, the pectoralis muscles 46 cover the chest.

As mentioned above, the various above-described muscle groups of the upper torso often interact to cause debilitating and/or painful conditions. Whereas conventional heating pads may successfully relax one group of muscles, this may fail to provide complete relief in the event that other muscle groups are involved. In the case that a condition is incompletely addressed, such condition may quickly if one or more effected muscle groups should go untreated. For example, tightness of the pectoralis muscles 46 can result in pulling one's shoulders forward. The pectoralis muscles 46 are arranged antagonistic, due to proximity, to the rhomboid muscles (not shown) that underlie the trapezius muscles 40, causing back strain. Tightness of the pectoralis muscles 46, by pulling the shoulders forward, pulls the head forward of the gravity line. This will also cause the posterior cervical muscle group 44 to be strained as it attempts to fight the effects of gravity. Such straining of these muscles can result in neck pain, headaches and disk irritation. Tight muscles in the upper and mid-thoracic regions can cause the same effect head and can cause tension to occur to the neck muscles and to the cervical spine.

The anatomical relationship between the posterior neck muscles, upper thoracic, mid-thoracic and upper chest muscles dictates that one muscle group cannot be involved without resulting involvement of the others. The upper chest and mid-thoracic muscles are antagonistic to one another. The muscles and posture of the neck and head are affected by those of the upper thoracic region much as a ladder is affected by changes in the surface upon which it rests.

Some muscles originate in the thoracic region, running to the neck or base of the skull. Treatment of muscles of the neck region that allows tension to remain in muscles of the upper back quickly causes tension to return to the neck muscles. In fact, relaxation of the muscles of the upper back often has a greater effect than direct treatment of the neck muscles.

Just as change of position of the middle floor of a building causes the overlying floors to be misaligned with respect to gravity, should imbalanced or tight upper chest or upper mid-back muscles will pull the shoulders or neck out of proper alignment with gravity, causing muscles in the effected areas to tighten in response to provide the required support of the body's structure to counter gravity.

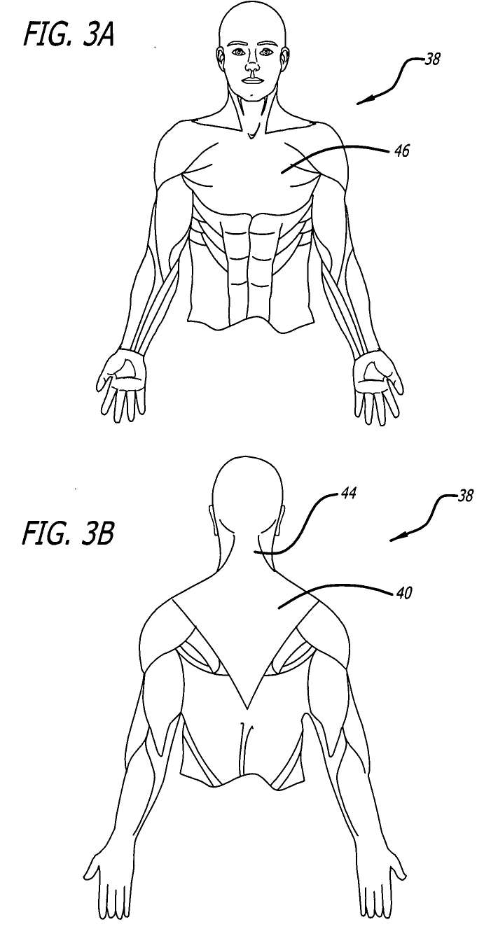

FIG. 4 is an exploded view illustrating the interior of the electric heating vest 10 in planar layout in accordance with an embodiment of the invention. As shown, the vest 10 includes a flexible matrix 48, preferably of canvas fabric, that forms a base for affixing an electrical heating element comprising the continuous elongated electrical cord 12. In an actual embodiment of the invention, the cord comprised 80 ohm wire 8 meters in length and an outer diameter of 4.2 millimeters.

The matrix 48 in layout generally resembles the head of a human or an animal with regions, outlined by dashed lines, resembling a “face” shaped region 50, a “scalp” shaped region 52 an a pair of radially-directed “ear” shaped regions 54, 56. Relating such portions to the above-described muscle groups of the upper torso, such regions of the vest 10, when worn by a user as illustrated in FIGS. 2A and 2B, overlie the trapezius muscles 40 of the upper back (the face shaped region 50 of the matrix 48), the posterior cervical muscle group 44 of the neck (the scalp shaped region 52 of the matrix 48) and the pectoralis muscles 46 of the chest (the ear shaped regions 54 and 56 of the matrix 48). As can be seen, and as is discussed below, the looped cord 12, is arranged to traverse each of the regions defined by the matrix 48 in a way that assures the comprehensive treatment of numerous problems associated with the musculature of the upper torso. Such comprehensive therapy is to be contrasted with prior art devices that fail to address some muscle groups of the upper torso that can serve as direct or indirect co-actors in the causation of muscle-related conditions.

The looped electrical cord 12 is fixed to the matrix 48 by means of a plurality of clips 58 to define a path thereover directed to the objective of delivering heat comprehensively to the above-described major muscle groups (and to the muscle groups that underlie such major groups) of the upper torso. The clips 58, which also fix a strip of cotton 53 thereover for stabilizing the configuration of the cord 12, are formed of a soft metal copper-lead or copper-aluminum alloy such as for user comfort.

Reviewing the general path of the looped cord 12 over the matrix 48 (proceeding left to right), it is observed that the cord 12 generally traces a path defined as follows: parallel to and throughout the length of the ear shaped region 54; continuing parallel to the side and lower edge of the face shaped region 50; reversing, after traversing the lower edge of the face shaped region 50 to form an “s” shape whose upper portion generally follows the upper edge of the scalp shaped region 52 then returns into the face shaped region 50; again reversing to trace a path generally parallel to the edges of and throughout the length of the ear shaped region 56. Looking back, the wiring of the vest, in layout, is thus characterized by the fact that (i) the looping cord 12 is generally radially directed and along the length of each of the ear shaped regions 54 and 56, (ii) it intersects the scalp shaped region 52, and (iii) begins to spread outwardly at the top then tapers downwardly to form a diamond-like shaped configuration in the face shaped region 50. Referring to FIGS. 2A and 2B of the vest 10 in use in combination with the musculature of the upper torso as illustrated in FIGS. 3A and 3B, it is seen that, by wearing the vest 10, heat is simultaneously delivered and specifically targeted to effectively target the major muscle groups (diamond shaped trapezius muscles, the pectoralis muscles and the cervical muscles) of the upper torso to apply therapeutic heat in an anatomically comprehensive manner for facilitating resolution of numerous muscle-involved conditions.

An inner cover 60 encloses the above-described arrangement. Such cover 60 is formed of fabric integrated with means for converting the resistive heat provided by the cord 12 into infrared heat. The looped configuration of the cord 12 acts to focus the resistive heating to facilitate the emission of infrared in a pattern that follows the pattern of heating provided by the cord 12.

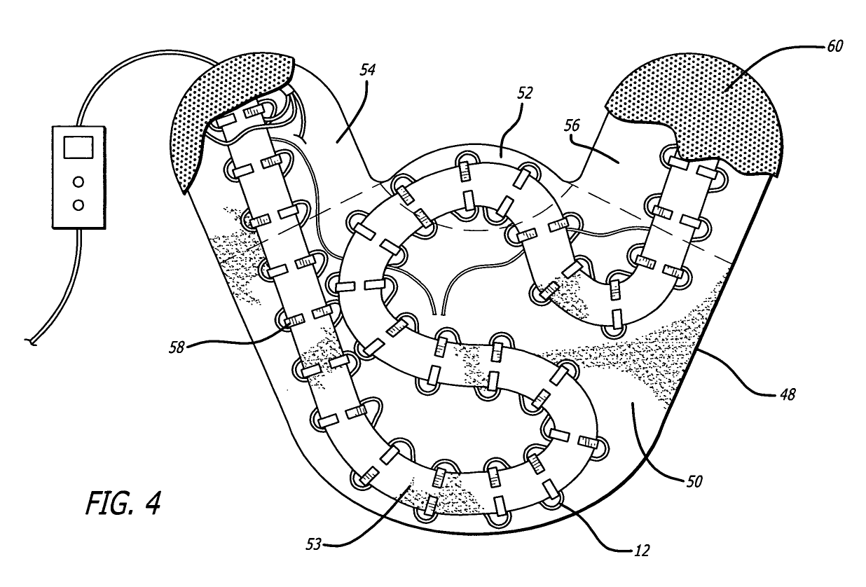

FIG. 5 is a cross-sectional view of the electric vest taken at line 5-5 of FIG. 2B. As can be seen, a clip 58 extends from the back of the matrix 48 to grasp a loop of the cord 12 and the overlying cotton strip 54 throughout the length of the looped cord 12. The cover 60 comprises opposed sheets 62, 64 of fabric having pluralities of dots 66 formed of a compound of Latex, infrared ceramic powder, fiber and bonding agent known by those skilled in the art to emit far infrared radiation in response to the application of heat. As such, localized emissions of far infrared radiation follow the pattern of heating provided by the path of the looped electrical cord 12 within the vest 10. The looping of the conductor 12 along the path tracing the major muscle groups of the upper torso acts to concentrate the emissions of infrared radiation along the path the electrical cord 12 traverses with respect to the flexible matrix 48. It is a characteristic of far infrared radiation that it can easily penetrate human tissue, creating a natural resonance due to the overlap between the far infrared spectrum and the resonant frequency of water molecules (which make up seventy per cent of the human body) that offers many beneficial properties without risk. Such far infrared radiation offers regenerative effects that further enhance the effectiveness of the heat provided by the vest 10.

Thus it is seen that the present invention provides an electric heating vest that offers significant advantages over existing apparatus. By applying the teachings of the invention, one may realize numerous therapeutic advantages. Conditions of the upper torso, involving the involved muscle groups can be treated in a comprehensive manner so that all involved groups are simultaneously addressed. This assures that the treatment is complete and that piecemeal and continuing heat therapy is not necessitated.

While this invention has been described with reference to its presently preferred embodiment, it is not limited thereto. Rather, the invention is limited only insofar as it is defined by the following set of patent claims and includes within its scope all equivalents thereof.

What is claimed is:

1. An electric heating vest for applying heat to predetermined areas of the body of a wearer comprising, in combination:
a) an electrical cord;
b) said electrical cord being fixed in a pattern on a flexible matrix having a boundary;
c) said flexible matrix being shaped to include regions for overlying predetermined muscle groups of the upper torso of said wearer; and
d) said pattern of said electrical cord traversing said regions of said flexible matrix shaped to overlie the pectoral, trapezius and posterior cervical muscle groups of said wearer.

2. An electric heating vest as defined in claim 1 further including a controller for receiving and converting an a.c. input into a selectable output for energizing said electrical cord.

3. An electric heating vest as defined in claim 2 wherein said electrical cord is looped throughout said regions of said flexible matrix.

4. An electric heating vest as defined in claim 3 further including a plurality of metal clips arranged along the length of said looped electrical cord for affixing said electrical cord to said flexible matrix.

5. An electric heating vest as defined in claim 4 wherein said flexible matrix comprises canvas.

6. An electric heating vest as defined in claim 5 further including a cover comprising opposed sheets of flexible material wherein each of said flexible sheets of material is substantially shaped and sized to conform to said flexible matrix.

7. An electric vest as defined in claim 6 wherein said cover includes material for emitting infrared radiation in response to the application of heat.

8. An electric heating vest as defined in claim 1 wherein said boundary of said flexible matrix defines a pattern resembling face-shaped, ear-shaped and scalp-shaped regions.

9. An electric heating vest as defined in claim 7 further characterized in that:
a) said face-shaped region is arranged to cover said trapezius muscle group;
b) said ear-shaped regions are arranged to cover said pectoral muscle group; and
c) said scalp-shaped region is arranged to cover said posterior cervical muscle group.

10. An electric heating vest as defined in claim 9 wherein said electrical cord traverses a generally-diamond shaped pattern within said face shaped region of said flexible matrix.

11. An electric heating vest as defined in claim 10 wherein said electrical cord traverses a major dimension of said scalp shaped region of said flexible matrix.

12. An electric heating vest as defined in claim 11 wherein said electrical cord traverses a major dimension of each of said ear shaped regions.
